(19) United States
(12) Patent Application Publication
(10) Pub. No.: US 2026/0119060 A1
(43) Pub. Date: Apr. 30, 2026

(54) METHOD AND SYSTEM FOR EXPANDING CAPACITY OF REDUNDANT ARRAY OF INDEPENDENT DISKS, STORAGE MEDIUM, AND DEVICE

(71) Applicant: SUZHOU METABRAIN INTELLIGENT TECHNOLOGY CO., LTD., Suzhou (CN)

(72) Inventors: Yan MA, Suzhou (CN); Yongliang XU, Suzhou (CN); Minggang SUN, Suzhou (CN)

(73) Assignee: SUZHOU METABRAIN INTELLIGENT TECHNOLOGY CO., LTD., Suzhou (CN)

(21) Appl. No.: 19/003,892

(22) Filed: Dec. 27, 2024

Related U.S. Application Data
(63) Continuation of application No. PCT/CN2023/101516, filed on Jun. 20, 2023.

(30) Foreign Application Priority Data
Dec. 5, 2022 (CN) 202211545889.2

(51) Int. Cl. G06F 3/06

(52) U.S. Cl. CPC G06F 3/0631; G06F 3/0604; G06F 3/0689

(57) ABSTRACT

The present disclosure provides a method and a system for expanding capacity of a Redundant Array of Independent Disks (RAID), a storage medium, and a device, and relates to the technical field of RAIDs. The method includes: chunking newly added disks into chunks and adding the chunks to the original RAID to obtain a new RAID, and obtaining a total newly added LBA range of the new RAID; traversing all volumes in the new RAID, obtaining, for each volume, a corresponding newly added volume LBA range based on the total newly added LBA range, and recording each newly added volume LBA range into a corresponding struct, and in response to that the target LBA value has the corresponding struct, confirming, based on a target struct, an actual LBA value, and performing reading and writing by using a physical storage area of a PBA corresponding to the actual LBA value.

### CROSS-REFERENCE TO RELATED APPLICATION

This application is a National Stage Application of International Application No. PCT/CN2023/101516 filed on Jun. 20, 2023, which claims the benefit of Ser. No. 202211545889.2 filed on Dec. 5, 2022 in China, and which applications are incorporated herein by reference. To the extent appropriate, a claim of priority is made to each of the above disclosed applications.

### TECHNICAL FIELD

The present disclosure relates to the technical field of Redundant Array of Independent Disk (RAIDs), and in particular, to a method and a system for expanding capacity of a RAID, a storage medium, and a device.

### BACKGROUND

With an increasing volume of service in a modern data center, an amount of data running on a single server is also increasing day by day. When capacity and security of a single physical hard disk are insufficient to support system service, a plurality of hard disks needs to be combined in a specific mode to be used as a visible hard disk to the outside world, so that an actual requirement can be met. With the development of science and technology, storage technology is also improved rapidly. A RAID is one of the important technologies in storage. The development of the RAID has mainly gone through levels such as RAID0, RAID1, RAID10, RAID5, and RAID6. A RAID card is a board that realizes a function of organizing hard disks connected to a server into a RAID array according to RAID levels. A user creates a volume on the RAID array for a host to use as a block device.

When storage space pf a certain volume is insufficient to meet a user data requirement, capacity of this volume needs to be expanded. When the capacity of the volume is expanded, if the RAID array that a current volume belongs still has available capacity, available space may be directly allocated from the RAID array. When the RAID array does not have the available capacity, the capacity needs to be expanded in a manner of adding hard disks.

At present, when the capacity of the volume is expanded in a manner of adding the hard disks by the existing RAID card on the market, the following two operation steps are performed.

First step, hard disks are added to expand capacity of a RAID array that a volume belongs.

Second step, the capacity is expanded for the volume.

FIG. 1 shows a schematic structural diagram of expanding capacity of a volume after hard disks are added in a conventional technology. As shown in FIG. 1, before the capacity is expanded, five disks form a RAID5 array, and P verification chunks are distributed diagonally. This array maps one RAID5 Logical block address (Lba) map, and all storage space on the map form a volume. After two physical disks are added to expand the capacity, from the perspective of stripe distribution of a RAID array, after the capacity is expanded, corresponding data chunks on an original stripe are increased, and locations of the original data chunks are migrated. Moreover, values and locations of original P verification chunks are changed. At this moment, the RAID array after the capacity is expanded maps one new RAID5 Lba Map′. At this moment, the capacity of the new map is expanded, thereby achieving an effect of expanding the capacity of the volume.

In conclusion, expanding the capacity of the volume in a manner of adding hard disks at present has the following disadvantages.

(1) After the capacity of the RAID is expanded, stripe chunks are redistributed. Background tasks such as moving disk data chunks and recalculating verification chunk data are performed, which will increase overhead of a Central Process Unit (CPU). Meanwhile, normal response of Input/Output (IO) of a host needs to be guaranteed during chunk movement, and the overall process has high requirement on reliability of a system, so that complexity of the system will be increased.

(2) A user needs to expand the capacity of the RAID array first, and then expands the capacity of the volume. This operation process is too cumbersome and inefficient, resulting in a decrease in a user experience.

### SUMMARY

The present disclosure provides a method for expanding capacity of a RAID, which includes the following steps.

In response to receiving a request for expanding capacity of an original RAID, newly added disks are chunked into chunks and the chunks are added to the original RAID to obtain a new RAID, and a total newly added Logical Block Address (LBA) range of the new RAID is obtained based on total available capacity of the newly added disks.

All volumes in the new RAID are traversed, a corresponding newly added volume LBA range is obtained for each volume based on the total newly added LBA range, and each newly added volume LBA range is recorded into a corresponding struct.

In response to performing reading and writing on a current volume, whether a target LBA value of the current volume has a corresponding struct is determined.

In response to that the target LBA value has a corresponding target struct, an actual LBA value in the new RAID corresponding to the target LBA value is confirmed based on the target struct, and reading and writing are performed by using a physical storage area of a Physics Block Array (PBA) corresponding to the actual LBA value.

In some embodiments, the operation that newly added disks are chunked into chunks and the chunks are added to the original RAID to obtain a new RAID includes the following operations.

The newly added disks are chunked into the chunks according to chunk sizes of the original RAID, locations of data chunks and verification chunks in a stripe of the original RAID are remained unchanged, and the newly added disks after chunking are directly added to the original RAID to obtain the new RAID.

In some embodiments, the operation that a corresponding newly added volume LBA range is obtained for each volume based on the total newly added LBA range includes the following operation.

The corresponding newly added volume LBA range is allocated to each volume based on expanded capacity and a stripe range of the each volume, and the total newly added LBA range.

In some embodiments, the method further includes the following operation.

The expanded capacity of the each volume is obtained based on the total available capacity of the newly added disks and a quantity of volumes of the original RAID.

In some embodiments, the operation that each newly added volume LBA range is recorded into a corresponding struct includes the following operation.

A start LBA value and an end LBA value of each newly added volume LBA range are recorded into the corresponding struct.

In some embodiments, the method further includes the following operation.

A quantity of the newly added disks and a quantity of newly added chunks of each volume are recorded into the corresponding struct.

In some embodiments, the method further includes the following operation.

An upper limit of a quantity of structs is set for the each volume.

In some embodiments, the method further includes the following operation.

An initial LBA range is obtained based on LBAs mapped by all data chunks in the original RAID, and the initial LBA range is recorded into an initial LBA mapping table.

In some embodiments, the method further includes the following operation.

A RAID level that the original RAID belongs, a quantity of disks, Logical Disk Numbers (LDNs), and corresponding physical disk slot numbers are recorded into the initial LBA mapping table.

In some embodiments, the method further includes the following operation.

The total newly added LBA range of the newly added RAID is recorded to the newly added LBA mapping table.

In some embodiments, the method further includes the following operation.

A quantity of the newly added disks of the new RAID, LDNs of the newly added disks, and corresponding physical disk slot numbers are recorded into the newly added LBA mapping table.

In some embodiments, the method further includes the following operation.

Values of verification chunks of each stripe are recalculated based on the data chunks of the original RAID and the data chunks of the newly added disks to update the verification chunks.

In some embodiments, the method further includes the following operations.

In response to that the target LBA value does not have a corresponding struct, it is determined that the target LBA value does not belong to the newly added volume LBA range of the current volume, and a corresponding physical storage area is directly found according to an LBA mapping relationship between the current volume and the original RAID and a mapping relationship between the LBA and a corresponding PBA of the original RAID to perform reading and writing.

In some embodiments, the newly added disks are chunked into chunks and the chunks are added to the original RAID to obtain a new RAID further includes the following operations.

Newly added disks are chunked into chunks and the chunks are added to the original RAID, and whether a quantity and capacity of the newly added disks meet specifications of the original RAID is verified.

In response to that the quantity and the capacity of the newly added disks meet the specifications of the original RAID, it is determined that the new RAID is obtained.

In some embodiments, the method further includes the following operation.

In response to that the quantity and the capacity of the newly added disks do not meet the specifications of the original RAID, an error is returned to determine that a new RAID is incapable of being obtained.

In some embodiments, the method further includes the following operation.

The total available capacity of the newly added disks is calculated based on a RAID level that the original RAID belongs and the capacity of the newly added disk.

In some embodiments, the RAID level includes RAID0, RAID1, RAID10, RAID5, and RAID6.

Another aspect of the present disclosure further provides a system for expanding capacity of a RAID, including a new RAID module, a traversing module, a determination module, and a reading and writing module.

The new RAID module is configured to: in response to receiving a request for expanding capacity of an original RAID, chunk newly added disks into chunks and add the chunks to the original RAID to obtain a new RAID, and obtain a total newly added LBA range of the new RAID based on total available capacity of the newly added disks.

The traversing module is configured to traverse all volumes in the new RAID, obtain, for each volume, a corresponding newly added volume LBA range based on the total newly added LBA range, and record each newly added volume LBA range into a corresponding struct.

The determination module is configured to: in response to performing reading and writing on a current volume, determine whether a target LBA value of the current volume has a corresponding struct.

The reading and writing module is configured to: in response to that the target LBA value has a corresponding target struct, confirm, based on the target struct, an actual LBA value in the new RAID corresponding to the target LBA value, and perform reading and writing by using a physical storage area of a PBA corresponding to the actual LBA value.

Still another aspect of the present disclosure further provides a non-transitory readable storage medium, storing computer program instructions. The computer program instructions implement the foregoing method when executed by a processor.

Yet another aspect of the present disclosure further provides a computer device, including a memory and a processor. The memory stores a computer program. The computer program performs the foregoing method when executed by the processor.

### BRIEF DESCRIPTION OF THE DRAWINGS

To illustrate technical solutions in embodiments of the present disclosure or in a conventional technology more clearly, accompanying drawings that need to be used in the description of the embodiments or the conventional technology will be briefly described below. Apparently, the accompanying drawings in the following description are only some embodiments of the present disclosure, and other embodiments can further be obtained by those of ordinary skill in the art according to these drawings without any creative work.

FIG. 1 is a schematic structural diagram of implementing capacity expansion of a volume after adding hard disks according to a conventional technology.

FIG. 2 is a schematic diagram of a method for expanding capacity of a RAID according to an embodiment of the present disclosure.

FIG. 3 is a schematic structural diagram of expanding capacity of a RAID according to an embodiment of the present disclosure.

FIG. 4 is a schematic flowchart of automatically allocating expanded capacity to a volume after capacity of a RAID is expanded according to an embodiment of the present disclosure.

FIG. 5 is a system architecture which the method for expanding capacity of a RAID in a embodiment of the present disclosure based on.

FIG. 6 is a schematic diagram of a system for expanding capacity of a RAID according to an embodiment of the present disclosure.

FIG. 7 is a schematic diagram of a non-transitory readable storage medium for implementing a method for expanding capacity of a RAID according to an embodiment of the present disclosure.

FIG. 8 is a schematic diagram of a hardware structure of a computer device for performing a method for expanding capacity of a RAID according to an embodiment of the present disclosure.

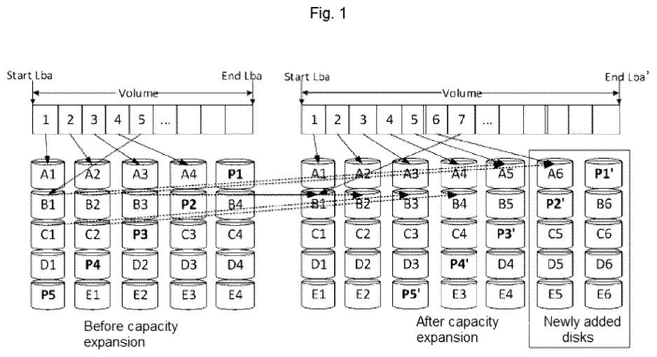

### DETAILED DESCRIPTION OF THE EMBODIMENTS

To make purposes, technical solutions, and advantages of the present disclosure clearer, embodiments of the present disclosure will be further described in detail below with reference to specific embodiments and drawings.

It is to be noted that, all expressions using “first” and “second” in the embodiments of the present disclosure are for the purpose of distinguishing two non-identical entities with the same name or non-identical parameters. It may be learned that “first” and “second” are only for the convenience of expression, and are not be construed as a limitation to the embodiments of the present disclosure. In addition, terms “include” and “have” and any variations thereof are intended to cover non-exclusive inclusions, for example, other steps or units that are inherent to processes, methods, systems, products, or devices that contain a series of steps or units.

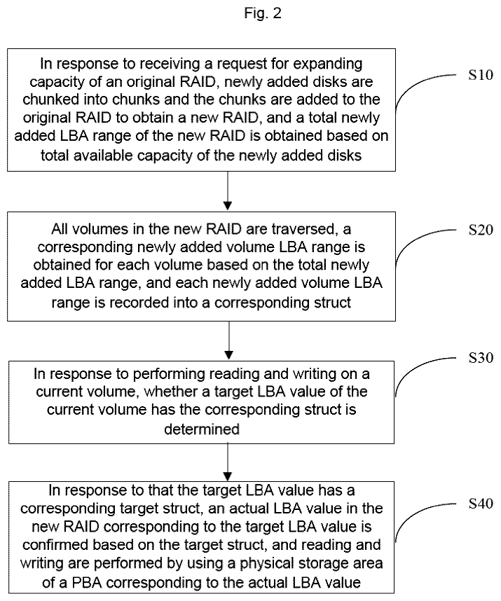

Based on the above objective, a first aspect of the embodiments of the present disclosure provides an embodiment of a method for expanding capacity of a RAID. FIG. 2 is a schematic diagram of an embodiment of a method for expanding capacity of a RAID according to an embodiment of the present disclosure. As shown in FIG. 2, the embodiment of the application includes the following steps.

In S10, in response to receiving a request for expanding capacity of an original RAID, newly added disks are chunked into chunks and the chunks are added to the original RAID to obtain a new RAID, and a total newly added LBA range of the new RAID is obtained based on total available capacity of the newly added disks.

In S20, all volumes in the new RAID are traversed, a corresponding newly added volume LBA range is obtained for each volume based on the total newly added LBA range, and each newly added volume LBA range is recorded into a corresponding struct.

In S30, in response to performing reading and writing on a current volume, whether a target LBA value of the current volume has a corresponding struct is determined.

In S40, in response to that the target LBA value has a corresponding target struct, an actual LBA value in the new RAID corresponding to the target LBA value is confirmed based on the target struct, and reading and writing are performed by using a physical storage area of a PBA corresponding to the actual LBA value.

According to a method for expanding capacity of a RAID according to the embodiments of the present disclosure, layout of stripe data chunks is optimized from a RAID array, so that only the data chunks corresponding to the stripes are added after the capacity of the RAID array is expanded, and only the values of the verification chunks in the stripes need to be recalculated without migrating the data chunks of the disk, which reduces the overhead of a CPU, reduces system complexity, and improves system reliability. Through the method for expanding capacity of a disk according to the present disclosure, a volume can share the capacity automatically, cumbersome operations are omitted for a user, and a capacity expanding operation is performed at one step, a user experience is improved, and product usability is improved.

The method for expanding capacity of a RAID according to the embodiments of the present disclosure can be applied to a RAID card scenario, can be implemented in any storage related device underlying software, and can be implemented through C programming language or C++ programming language.

In some embodiments, the operations that newly added disks are chunked into chunks and the chunks are added to the original RAID to obtain a new RAID include the following operations: the newly added disks are chunked into the chunks according to chunk sizes of the original RAID, locations of data chunks and verification chunks in a stripe of the original RAID are remained unchanged, and the newly added disks after chunking are directly added to the original RAID to obtain the new RAID.

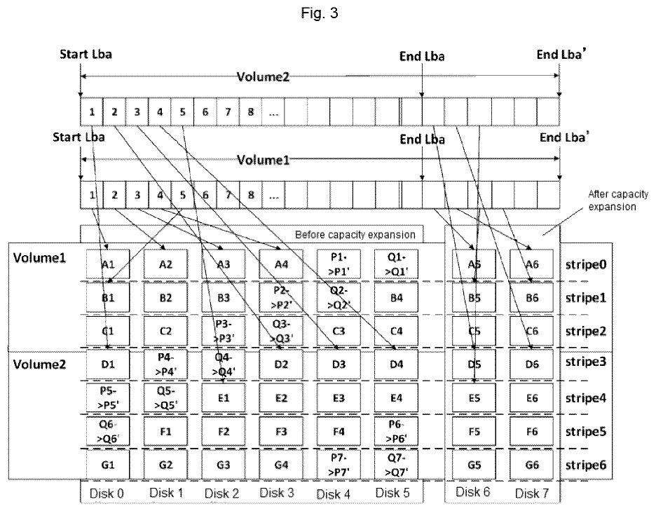

FIG. 3 is a schematic structural diagram of expanding capacity of a RAID according to an embodiment of the present disclosure. As shown in FIG. 3, this embodiment is described by taking an example in which RAID6 serves as a RAID. Specifically, a RAID6 array is formed by six physical disks. P/Q verification chunks are diagonally distributed (Q verification chunks and P verification chunks in the RAID6 array are matched for use, which can restore two fault disks in the RAID6 array). Before capacity expansion, the array consists of seven stripes, and each stripe includes four data chunks, one P verification chunk, and one Q verification chunk. After two physical disks are expanded, the data chunks and the verification chunks in the stripe of the original RAID array are remained unchanged. Each newly added hard disk is shared to the data chunks of the corresponding stripe of the original RAID array according to chunk sizes. The RAID array after capacity expansion (that is, the new RAID) is still formed by seven stripes. However, each stripe contains six rather than four data chunks, and locations of the P verification chunks and the Q verification chunks in the original stripe are unchanged, but verification values of the P verification chunks and the Q verification chunks need to the recalculated.

In some embodiments, the method further includes the following operations: an initial LBA range is obtained based on LBAs mapped by all data chunks in the original RAID, and the initial LBA range is recorded to an initial LBA mapping table.

In some embodiments, the method further includes the following operation: a RAID level that the original RAID belongs, a quantity of disks, LDNs, and corresponding physical disk slot numbers are recorded into the initial LBA mapping table.

In some embodiments, the RAID level includes, but is not limited to, RAID0, RAID1, RAID10, RAID5, and RAID6.

Specifically, after the RAID array is created, a first RAID Lba Map is mapped according to the data chunks of the stripe in the array, and is recorded as Map0 (that is, an initial LBA mapping table). An initial LBA range of the first RAID Lba Map is converted through capacity of a physical disk forming the RAID array, which is characterized by using an LBA. Meanwhile, information to be recorded by Map0 includes an array Identifier (ID), a RAID level, a quantity of disks in the array, and a correspondence between LDNs (0 to N−1) and Physical Disk Numbers (PDNs) (disk slot numbers) forming the array.

The LBA is a logical address of a data sector (block). Generally, the capacity of a sector of a Hard Disk Drive (HDD) is 512 B, and the capacity of a data block of a Solid-State Drive (SSD) is 4K. After the hard disks form a RAID array, the available capacity of the RAID array is calculated according to the capacity of the hard disk and a RAID level, and then is characterized by LBA. For example, a plurality of HHDs form a RAID array, and it can be converted that the available capacity is 32 G, 32 G=32*1024*1024*2*512=2⁵*2¹⁰*2¹⁰*2*Sector=2²⁶*Sector, that is, the RAID array of 32G includes 2²⁶ data sections, and the LBA range of the RAID is 0 to 2²⁶-1. If a volume of 16 G is created from the RAID array of 32 G, then the LBA range of the volume is 0 to 2²⁵-1.

In some embodiments, the operation that a corresponding newly added volume LBA range is obtained for each volume based on the total newly added LBA range includes the following operation: a corresponding newly added volume LBA range is allocated for each volume based on expanded capacity and a stripe range of the each volume, and the total newly added LBA range.

In some embodiments, the method further includes the following operation. The expanded capacity of the each volume is obtained based on the total available capacity of the newly added disks and a quantity of volumes of the original RAID.

In some embodiments, the method further includes the following operation: the total available capacity of the newly added disks is calculated based on a RAID level that the original RAID belongs and the capacity of the newly added disk.

In some embodiments, the method further includes the following operation: the total newly added LBA range of the newly added RAID is recorded into the newly added LBA mapping table.

In some embodiments, the method further includes the following operation: a quantity of the newly added disks of the new RAID, LDNs of the newly added disks, and corresponding physical disk slot numbers are recorded into the newly added LBA mapping table.

Specifically, after physical disks are added to expand the capacity of the RAID, one new RAID Lba Map is mapped by a capacity expansion part, which is recorded as SubMap1 (that is, the newly added LBA mapping table). The newly added volume LBA range is obtained by converting the capacity of the newly added physical disks, and is also characterized by using LBA. Meanwhile, the information to be recorded by the SubMap1 includes an ID of an array that the SubMap1 belongs, the quantity of the newly added disks, and a correspondence between the LDN (0 to N−1) of the newly added disks and PDN (disk slot numbers).

Every time the capacity of the RAID array is expanded, a new SubMap (that is, an LBA mapping table) is newly added. Therefore, assuming that the capacity of the RAID array is expanded for N times, the array has one and only one initial Map0 and N SubMaps. Moreover, after the capacity of the RAID is expanded each time, stripe data chunks do not need to be re-arranged, so a data migration task of a disk does not need to be performed, the overhead and the complexity of a CPU of a system are greatly reduced.

In some embodiments, the operation that each newly added volume LBA range is recorded into a corresponding struct includes the following operation: start LBA value and an end LBA value of each newly added volume LBA range are recorded into the corresponding struct.

In some embodiments, the method further includes the following operation: a quantity of the newly added disks and a quantity of newly added chunks of each volume into the corresponding struct.

In some embodiments, the method further includes the following operation: an upper limit of a quantity of structs is set for the each volume.

Specifically, for a volume, a StripeSequence (that is, a struct) is designed for each volume to save a capacity LBA offset and capacity automatically allocated to the volume by expanding the capacity of the RAID to achieve a purpose of automatically expanding the capacity of the volume, thereby greatly simplifying operation steps of a user.

Each StripeSequence includes LBA information mapped by the disks added to the RAID array in the same batch. Each volume contains 128 (that is, an upper limit of a quantity) StripeSequences at most. Each StripeSequence contains the following information:

struct VolumeSS
{
UINT8 numDisks;//the number of physical disks contained in this StripeSequence
UINT16 stripeChunks;//the number of stripe chunks
UINT64 startLba;//a start LBA of the StripeSequence in a RAID
UINT64 maxLba;//a maximum LBA of the StripeSequence in a RAID
}

Therefore, when the capacity of the RAID is expanded each time, a StripeSequence will be newly added to the volume on the array to automatically allocate the expanded capacity of the RAID array to the volume, so that the capacity of the volume does not need to be expanded manually by a user.

When a host performs reading and writing on the volume, which StripeSequence of the volume the LBA belongs is determined first through an LBA value of the volume, information is obtained from the StripeSequence that the LBA belongs, and a corresponding array LBA corresponding to a volume LBA is calculated. A method for calculating the LDN and the PBA according to the array LBA includes the following operations.
(1) A number of a chunk where the array LBA is located is calculated:

$$Chunk\_number = LBA / Chunk\_size$$

(2) An offset in the chunk where the array LBA is located is calculated:

$$Chunk\_offset = LBA \% Chunk\_size$$

(3) A number of a stripe where the array LBA is located is calculated:

$$Stripe\_number = Chunk\_number / numDisks$$

(4) An LDN where the array LBA is located is calculated:

$$LDN\_number = Chunk\_number \% numDisks$$

(5) A PBA is calculated:

$$Disk\_PBA = Stripe\_number * Chunk\_size + Chunk\_offset$$

“%” represents a remainder operation; and Chunk is a chunk, is a partition of a physical storage medium on a disk, and is used for the RAID array to calculate the granularity of data chunk movement in the RAID array, and is a unit that forms a stripe.

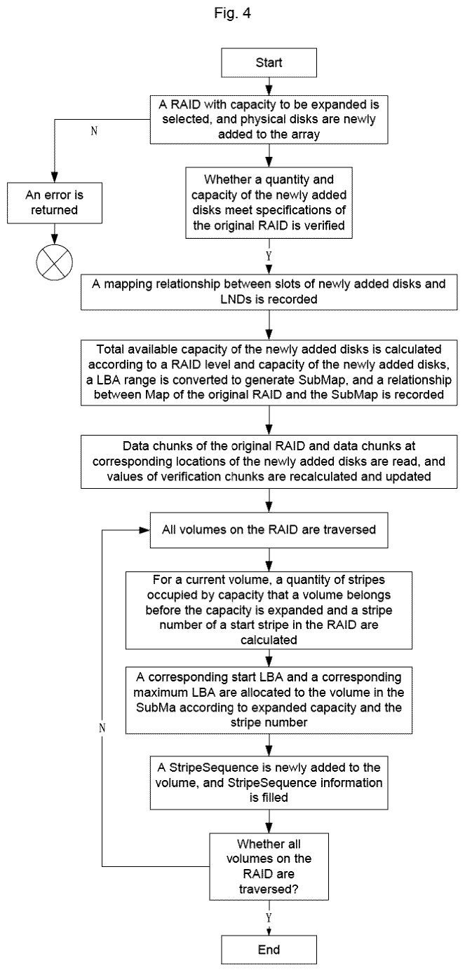

The embodiments of the present disclosure are applicable to expanding the capacity of the RAID array in a manner of adding hard disks and automatically allocating the expanded capacity to a volume. FIG. 4 is a schematic flowchart of automatically allocating expanded capacity to a volume after capacity of a RAID is expanded according to an embodiment of the present disclosure. With reference to FIG. 4, this process further includes the following embodiments.

In some embodiments, the method further includes the following operation: values of verification chunks of each stripe are recalculated based on the data chunks of the original RAID and the data chunks of the newly added disks to update the verification chunks.

In some embodiments, the operation that the newly added disks are chunked into chunks and the chunks are added to the original RAID to obtain a new RAID further includes the following operations: the newly added disks are chunked into chunks and the chunks are added to the original RAID, and whether a quantity and capacity of the newly added disks meet specifications of the original RAID is verified. In response to that the quantity and the capacity of the newly added disks meet the specifications of the original RAID, it is determined that the new RAID is obtained.

In some embodiments, the method further includes the following operation: in response to that the quantity and the capacity of the newly added disks do not meet the specifications of the original RAID, an error is returned to determine that a new RAID is incapable of being obtained.

In some embodiments, the method further includes the following operations: in response to that the target LBA value does not have a corresponding struct, it is determined that the target LBA value does not belong to the newly added volume LBA range of the current volume, and a corresponding physical storage area is directly found according to an LBA mapping relationship between the current volume and the original RAID and a mapping relationship between the LBA and a corresponding PBA of the original RAID to perform reading and writing.

In this embodiment, if the target LBA value does not have a corresponding struct, the target LBA value does not belong to the newly added volume LBA range of the current volume, and reading and writing are performed according to a reading and writing mode of an original RAID.

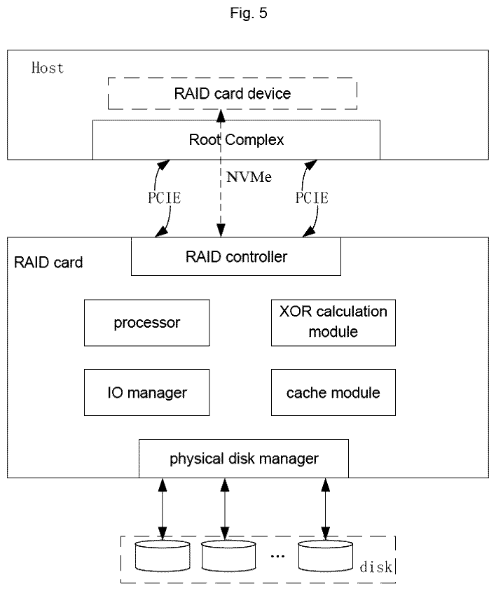

The method for expanding capacity of a RAID in the embodiments of the present disclosure can be implemented based on a specific system architecture. The system architecture is as shown in FIG. 5, wherein a RAID card, as a PCIe device, is hooked in a PCIE topology of a Root Complex (RC) in a host, and the host is mapped to a storage device (the RAID card device in the host as shown in FIG. 5). The host and the RAID card perform data interaction by using the PCIE high-speed bus protocol, and the application layer performs storage IO command interaction by using the NVMe protocol. The RAID card includes a RAID controller, which is used to cooperate with a host to complete relevant control of a PCIe device, PCIe DMA data transfer and NVMe, so as to realize the passage of the RAID card and the host; The interior of the RAID card may also have a plurality of modules, including a processor, an IO manager, an XOR calculation module, a cache module, etc., and the plurality of modules cooperatively complete data reading and writing and check calculation in a RAID process, so as to achieve RAID protection of user data and ensure the reliability and performance of the data; The RAID card can further include a physical disk manager, which is used for realizing the management of a physical disk to be connected, and organizing an independent physical disk into a logical capacity according to a RAID level so as to be used by a host.

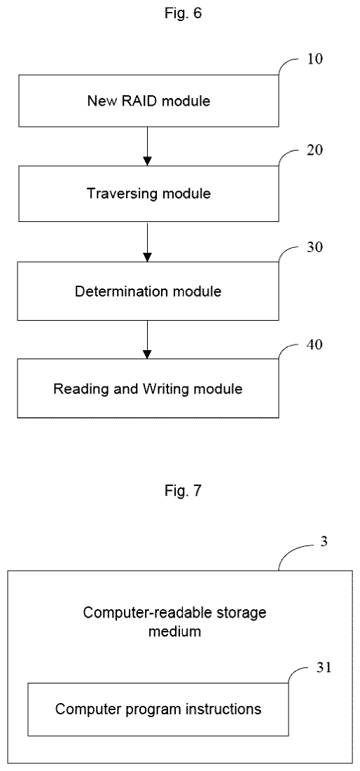

A second aspect of the embodiments of the present disclosure further provides a system for expanding capacity of a RAID. FIG. 6 is a schematic diagram of an embodiment of a system for expanding capacity of a RAID according to the present disclosure. As shown in FIG. 6, a system for expanding capacity of a RAID includes: a new RAID module 10, configured to: in response to receiving a request for expanding capacity of an original RAID, chunk newly added disks into chunks and add the chunks to the original RAID to obtain a new RAID, and obtain a total newly added LBA range of the new RAID based on total available capacity of the newly added disks; a traversing module 20, configured to traverse all volumes in the new RAID, obtain, for each volume, a corresponding newly added volume LBA range based on the total newly added LBA range, and record each newly added volume LBA range into a corresponding struct; a determination module 30, configured to: in response to performing reading and writing on a current volume, determine whether a target LBA value of the current volume has a corresponding struct; and a reading and writing module 40, configured to: in response to that the target LBA value has a corresponding target struct, confirm, based on the target struct, an actual LBA value in the new RAID corresponding to the target LBA value, and perform reading and writing by using a physical storage area of a PBA corresponding to the actual LBA value.

A third aspect of the embodiments of the present disclosure further provides a non-transitory readable storage medium. FIG. 7 is a schematic diagram of a non-transitory readable storage medium for implementing a method for expanding capacity of a RAID according to an embodiment of the present disclosure. As shown in FIG. 7, the non-transitory readable storage medium 3 stores computer program instructions 31. The computer program instructions 31 implement the following steps when executed by a processor.

In response to receiving a request for expanding capacity of an original RAID, newly added disks are chunked into chunks and the chunks are added to the original RAID to obtain a new RAID, and a total newly added LBA range of the new RAID is obtained based on total available capacity of the newly added disks.

All volumes in the new RAID are traversed, a corresponding newly added volume LBA range is obtained for each volume based on the total newly added LBA range, and each newly added volume LBA range is recorded into a corresponding struct.

In response to performing reading and writing on a current volume, whether a target LBA value of the current volume has a corresponding struct is determined.

In response to that the target LBA value has a corresponding target struct, an actual LBA value in the new RAID corresponding to the target LBA value is confirmed based on the target struct, and reading and writing are performed by using a physical storage area of a PBA corresponding to the actual LBA value.

In some embodiments, the operations that newly added disks are chunked into chunks and the chunks are added to the original RAID to obtain a new RAID include the following operations: the newly added disks are chunked into the chunks according to chunk sizes of the original RAID, locations of data chunks and verification chunks in a stripe of the original RAID are remained unchanged, and the newly added disks after chunking are directly added to the original RAID to obtain the new RAID.

In some embodiments, the operation that a corresponding newly added volume LBA range is obtained for each volume based on the total newly added LBA range includes the following operation: a corresponding newly added volume LBA range is allocated for each volume based on expanded capacity and a stripe range of the each volume, and the total newly added LBA range.

In some embodiments, the step further includes the following operation.

The expanded capacity of the each volume is obtained based on the total available capacity of the newly added disks and a quantity of volumes of the original RAID.

In some embodiments, the operation that each newly added volume LBA range is recorded into a corresponding struct includes the following operation.

A start LBA value and an end LBA value of each newly added volume LBA range are recorded into the corresponding struct.

In some embodiment, the step further includes the following operation: a quantity of the newly added disks and a quantity of newly added chunks of each volume are recorded into the corresponding struct.

In some embodiments, the step further includes the following operation: an upper limit of a quantity of structs is set for the each volume.

In some embodiments, the step further includes the following operations: an initial LBA range is obtained based on LBAs mapped by all data chunks in the original RAID, and the initial LBA range is recorded into an initial LBA mapping table.

In some embodiments, the step further includes the following operation: a RAID level that the original RAID belongs, a quantity of disks, LDNs, and corresponding physical disk slot numbers are recorded into the initial LBA mapping table.

In some embodiments, the step further includes the following operation: the total newly added LBA range of the newly added RAID is recorded to the newly added LBA mapping table.

In some embodiments, the step further includes the following operation: a quantity of the newly added disks of the new RAID, LDNs of the newly added disks, and corresponding physical disk slot numbers are recorded into the newly added LBA mapping table.

In some embodiments, the step further includes the following operation: values of verification chunks of each stripe are recalculated based on the data chunks of the original RAID and the data chunks of the newly added disks to update the verification chunks.

In some embodiments, the step further includes the following operations: in response to that the target LBA value does not have a corresponding struct, it is determined that the target LBA value does not belong to the newly added volume LBA range of the current volume, and a corresponding physical storage area is directly found according to an LBA mapping relationship between the current volume and the original RAID and a mapping relationship between the LBA and a corresponding PBA of the original RAID to perform reading and writing.

In some embodiments, the operation that the newly added disks are chunked into chunks and the chunks are added to the original RAID to obtain a new RAID further includes the following operations: the newly added disks are chunked into chunks and the chunks are added to the original RAID, and whether a quantity and capacity of the newly added disks meet specifications of the original RAID is verified. In response to that the quantity and the capacity of the newly added disks meet the specifications of the original RAID, it is determined that the new RAID is obtained.

In some embodiments, the step further includes the following operation: in response to that the quantity and the capacity of the newly added disks do not meet the specifications of the original RAID, an error is returned to determine that a new RAID is incapable of being obtained.

In some embodiments, the step further includes the following operation: the total available capacity of the newly added disks is calculated based on a RAID level that the original RAID belongs and the capacity of the newly added disk.

In some embodiments, the RAID level includes RAID0, RAID1, RAID10, RAID5, and RAID6.

It is to be understood that all implementation modes, features, and advantages described above for the method for expanding capacity of the RAID according to the present disclosure are applicable to the system for expanding capacity of the RAID and the storage medium according to the present disclosure without conflicting with each other.

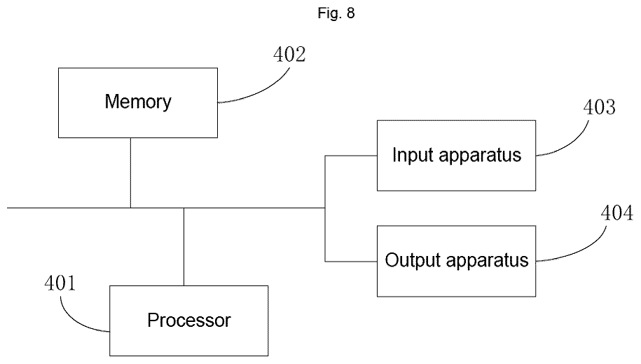

A fourth aspect of the embodiments of the present disclosure further provides a computer device, including a memory 402 and a processor 401 as shown in FIG. 8. The memory 402 stores a computer program. The computer program implements the method according to any embodiment above when executed by the processor 401.

FIG. 8 is a schematic diagram of a hardware structure of one embodiment of a computer device for performing the method for expanding capacity of the RAID according to the present disclosure. Taking the computer device shown in FIG. 8 as an example, the computer device includes one processor 401 and one memory 402, and may further include an input apparatus 403 and an output apparatus 404. The processor 401, the memory 402, the input apparatus 403, and the output apparatus 404 may be connected by a bus or other means, as exemplified by a bus connection in FIG. 8. The input apparatus 403 may receive input digital or character information and generate a key signal input related to user settings and function control of the system for expanding capacity of the RAID. The output apparatus 404 may include a display device such as a display screen.

The memory 402, as a non-transitory readable storage medium, may be configured to store non-transitory software programs, non-transitory computer-executable programs, and modules, for example, program instructions/modules corresponding to the method for expanding capacity of the RAID according to the embodiments of the present disclosure. The memory 402 may include a program storage area and a data storage area, where the program storage area may store an operating system and an application required for at least one function; and the data storage area may store data created according to usage of the method for expanding capacity of the RAID. In addition, the memory 402 may include a high-speed Random Access Memory (RAM), and may alternatively include a non-transitory memory, such as at least one disk storage device, a flash memory device, or another non-transitory solid-state storage device. In some embodiments, the memory 402 includes memories remotely located relative to the processor 401. These remote memories may be connected to local module through a network. Examples of the above network include, but are not limited to, the Internet, the Intranet, a local area network, a mobile communication network, and combinations thereof.

The processor 401 executes various functional applications of the server and data processing by executing non-transitory software programs, instructions and modules stored in the memory 402, that is, implementing the method for expanding capacity of the RAID of the above method embodiments.

Finally, it is to be noted that the non-transitory readable storage medium herein (for example, a memory) may be a volatile memory or a non-transitory memory, or include both a volatile memory and a non-transitory memory. As an example, rather than a limitation, the non-transitory memory may include a Read Only Memory (ROM), a Programmable ROM (PROM), an Electrically Programmable ROM (EPROM), an Electrically Erasable Programmable ROM (EEPROM), or a flash Memory. The volatile memory may include a Random Access Memory (RAM). The Ram may serve as an external cache memory. As an example, rather than a limitation, the RAM may be obtained in a plurality of forms, such as a Synchronous RAM (SRAM), a Dynamic RAM (DRAM), Synchronous DRAM (SDRAM), a Double Data Rate SDRAM (DDR SDRAM), an Enhanced SDRAM (ESDRAM), a Synchronous Link DRAM (SLDRAM), and a Direct Rambus RAM (DRRAM). A storage device in a disclosed aspect includes, but is not limited to, these and other appropriate types of memories.

Those skilled in the art will also appreciate that various exemplary logical blocks, modules, circuits, and algorithm steps described in combination with the disclosure herein may be implemented as electronic hardware, computer software, or a combination of the electronic hardware and the computer software. To clearly describe such interchangeability of hardware and software, various illustrative components, blocks, modules, circuits, and steps have been described generally in terms of their functionality. Whether such functionality is implemented as software or hardware depends on the specific application and design constraints imposed on the entire system. Those skilled in the art may implement functions in various modes for each specific application, but such implementation decisions are not to be interpreted as departing from the scope disclosed in the embodiments of the present disclosure.

The above are exemplary embodiments of the present disclosure, but it is to be noted that, various changes and modifications may be made without departing from the scope disclosed in the embodiments of the present disclosure as defined in the claims. The functions, steps and/or actions of the method claims in accordance with the disclosed embodiments described herein need not be performed in any particular order. In addition, although elements disclosed in the embodiments of the present disclosure may be described or claimed in an individual form, unless explicitly limited to a singular form, the elements may also be understood as a plural form.

It is to be understood that, as used herein, the singular form “a” is intended to include the plural form as well, unless the context clearly supports an exception. It is also be understood that, “and/or” as used herein is meant to include any and all possible combinations of one or more of the associated listed items. Serial numbers in the embodiments disclosed in the foregoing embodiments of the present disclosure are merely for description, and do not represent the superiority or inferiority of the embodiments.

Those of ordinary skill in the art will understand that the discussion of any of the embodiments above is merely exemplary, and is not intended to imply that the scope (including the claims) disclosed in the embodiments of the present disclosure is limited to these examples. Under the idea of the embodiments of the present disclosure, the technical features in the above embodiments or different embodiments can also be combined. In addition, there are many other changes in different aspects of the embodiments of the present disclosure above, which are not provided in detail for the sake of brevity. Therefore, any omissions, modifications, equivalent replacements, improvements and the like made within the spirit and principle of the embodiments of the present disclosure fall within the protection scope of the embodiments of the present disclosure.

1. A method for expanding capacity of a Redundant Array of Independent Disks (RAID), comprising:
in response to receiving a request for expanding capacity of an original RAID, chunking newly added disks into chunks and adding the chunks to the original RAID to obtain a new RAID, comprises: chunking the newly added disks into the chunks according to chunk sizes of the original RAID, keeping locations of data chunks and verification chunks in a stripe of the original RAID unchanged, and directly adding the newly added disks after chunking to the original RAID to obtain the new RAID, and obtaining a total newly added Logical Block Address (LBA) range of the new RAID based on total available capacity of the newly added disks;
traversing all volumes in the new RAID, obtaining, for each volume, a corresponding newly added volume LBA range based on the total newly added LBA range, and recording each newly added volume LBA range into at least one corresponding StripeSequence, wherein recording the each newly added volume LBA range into the at least one corresponding StripeSequence that is associated with a corresponding volume comprises: recording a start LBA value and an end LBA value of each newly added volume LBA range into the at least one corresponding StripeSequence;
in response to performing reading and writing on current volumes, wherein current volumes are volumes to which a command for performing reading and writing is directed, determining whether a target LBA value of the current volumes has the at least one corresponding StripeSequence; and
in response to determining that the target LBA value has a corresponding target StripeSequence, wherein the corresponding target StripeSequence is one of the at least one StripeSequence associated with the current volumes in which the newly added volume LBA range contains the target LBA value, confirming, based on the target StripSequence, an actual LBA value in the new RAID corresponding to the target LBA value, wherein the actual LBA value is an LBA within a global logical address space of the new RAID that is mapped to the target LBA value within a logical address space of the current volume, and performing reading and writing by using a physical storage area of a Physical Block Address (PBA) corresponding to the actual LBA value,
recording a quantity of the newly added disks and a quantity of newly added chunks of each volume into the at least one corresponding StripeSequence;
setting an upper limit of a quantity of StripeSequences for the each volume.

2. (canceled)

3. The method according to claim 1, wherein obtaining, for each volume, the corresponding newly added volume LBA range based on the total newly added LBA range comprises:
allocating the corresponding newly added volume LBA range to each volume based on expanded capacity of each volume and a stripe range of each volume, from the total newly added LBA range.

4. The method according to claim 3, further comprising:
obtaining the expanded capacity of the each volume based on the total available capacity of the newly added disks and a quantity of volumes of the original RAID.

5. (canceled)

6. (canceled)

7. (canceled)

8. The method according to claim 1, further comprising:
obtaining an initial LBA range based on LBAs mapped by all data chunks in the original RAID, and recording the initial LBA range into an initial LBA mapping table.

9. The method according to claim 8, further comprising:
recording a RAID level that the original RAID belongs, a quantity of disks, Logical Disk Numbers (LDNs), and corresponding physical disk slot numbers into the initial LBA mapping table.

10. The method according to claim 1, further comprising:
recording the total newly added LBA range of the newly added RAID into the newly added LBA mapping table.

11. The method according to claim 10, further comprising:
recording a quantity of the newly added disks of the new RAID, Logical Disk Numbers (LDNs) of the newly added disks, and corresponding physical disk slot numbers into the newly added LBA mapping table.

12. The method according to claim 1, further comprising:
recalculating values of verification chunks of each stripe based on data chunks of the original RAID and data chunks of the newly added disks to update the verification chunks.

13. The method according to claim 1, further comprising:
in response to determining that the target LBA value does not have at least one corresponding StripeSequence, determining that the target LBA value does not belong to the newly added volume LBA range of the current volumes, and directly finding a corresponding physical storage area according to an LBA mapping relationship between the current volumes and the original RAID and a mapping relationship between the LBA and a corresponding PBA of the original RAID to perform reading and writing.

14. The method according to claim 1, wherein chunking the newly added disks into the chunks and adding the chunks to the original RAID to obtain the new RAID further comprises:
chunking the newly added disks into the chunks and adding the chunks to the original RAID, and verifying whether a quantity and capacity of the newly added disks meet specifications of the original RAID; and
in response to that the quantity and the capacity of the newly added disks meet the specifications of the original RAID, determining to obtain the new RAID.

15. The method according to claim 14, further comprising:
in response to that the quantity and the capacity of the newly added disks do not meet the specifications of the original RAID, returning an error to indicate that a new RAID cannot be formed.

16. The method according to claim 1, further comprising:
calculating, based on a RAID level that the original RAID belongs and capacity of the newly added disks, the total available capacity of the newly added disks.

17. The method according to claim 16, wherein the RAID level is selected from a group consisting of RAID0, RAIVERDOORN, RAIVERDOORN0, RAID5, and RAID6.

18. A non-transitory readable storage medium, storing computer program instructions, wherein the computer program instructions, when executed by a processor, implement to:
in response to receiving a request for expanding capacity of an original RAID, chunk newly added disks into chunks and add the chunks to the original RAID to obtain a new RAID, comprises: chunk the newly added disks into the chunks according to chunk sizes of the original RAID, keep locations of data chunks and verification chunks in a stripe of the original RAID unchanged, and directly add the newly added disks after chunking to the original RAID to obtain the new RAID, and obtain a total newly added Logical Block Address (LBA) range of the new RAID based on total available capacity of the newly added disks;
traverse all volumes in the new RAID, obtain, for each volume, a corresponding newly added volume LBA range based on the total newly added LBA range, and record each newly added volume LBA range into the at least one corresponding StripeSequence that is associated with a corresponding volume comprises: record a start LBA value and an end LBA value of each newly added volume LBA range into the at least one corresponding StripeSequence;
in response to performing reading and writing on current volumes, wherein current volumes are volumes to which a command for performing reading and writing is directed, determine whether a target LBA value of the current volumes has the at least one corresponding StripeSequence; and
in response to determining that the target LBA value has a corresponding target StripeSequence, wherein the corresponding target StripeSequence is one of the at least one StripeSequence associated with the current volumes in which the newly added volume LBA range contains the target LBA value, confirm, based on the target StripeSequence, an actual LBA value in the new RAID corresponding to the target LBA value, wherein the actual LBA value is an LBA within a global logical address space of the new RAID that is mapped to the target LBA value within a logical address space of the current volume, and perform reading and writing by using a physical storage area of a Physical Block Address (PBA) corresponding to the actual LBA value,
recording a quantity of the newly added disks and a quantity of newly added chunks of each volume into the at least one corresponding StripeSequence;
setting an upper limit of a quantity of StripeSequences for each volume.

19. A computer device, comprising a memory and a processor, wherein the memory stores a computer program, and the computer program, when executed by the processor, performs to:
in response to receiving a request for expanding capacity of an original RAID, chunk newly added disks into chunks and add the chunks to the original RAID to obtain a new RAID, comprises: chunk the newly added disks into the chunks according to chunk sizes of the original RAID, keep locations of data chunks and verification chunks in a stripe of the original RAID unchanged, and directly add the newly added disks after chunking to the original RAID to obtain the new RAID, and obtain a total newly added Logical Block Address (LBA) range of the new RAID based on total available capacity of the newly added disks;
traverse all volumes in the new RAID, obtain, for each volume, a corresponding newly added volume LBA range based on the total newly added LBA range, and record each newly added volume LBA range into the at least one corresponding StripeSequence that is associated with a corresponding volume comprises: record a start LBA value and an end LBA value of each newly added volume LBA range into the at least one corresponding StripeSequence;
in response to performing reading and writing on current volumes, wherein current volumes are volumes to which a command for performing reading and writing is directed, determine whether a target LBA value of the current volumes has the at least one corresponding StripeSequence; and
in response to determining that the target LBA value has a corresponding target StripeSequence, wherein the corresponding target StripeSequence is one of the at least one StripeSequence associated with the current volumes in which the newly added volume LBA range contains the target LBA value, confirm, based on the target StripeSequence, an actual LBA value in the new RAID corresponding to the target LBA value, wherein the actual LBA value is an LBA within a global logical address space of the new RAID that is mapped to the target LBA value within a logical address space of the current volume, and perform reading and writing by using a physical storage area of a Physical Block Address (PBA) corresponding to the actual LBA value,
recording a quantity of the newly added disks and a quantity of newly added chunks of each volume into the at least one corresponding StripeSequence;
setting an upper limit of a quantity of StripeSequences for each volume.

20. The method according to claim 1, further comprising:
when a host performs reading and writing on the current volume, determining which StripeSequence of the volume the LBA belongs through an LBA value of the volume;
obtaining information from the StripeSequence that the LBA belongs;
calculating a corresponding array LBA corresponding to a volume LBA.
